(19) United States
(12) Patent Application Publication
(10) Pub. No.: US 2007/0284850 A1
(43) Pub. Date: Dec. 13, 2007

(54) Cantilevered wagon running gear

(76) Inventors: Dale E. Husted, Rolling Prairie, IN (US); Robert G. Lauson, Porter, IN (US)

Correspondence Address: Hamilton Sundstrand Corporation, 4747 Harrison Avenue (110-6), P.O. Box 7002, Rockford, IL, 61125-7002, US

(21) Appl. No.: 11/449,249

(22) Filed: Jun. 8, 2006

(51) Int. Cl. B62D 13/00

(52) U.S. Cl. 280/444

(57) ABSTRACT

A running gear for a wagon comprises a cantilever extending away from one end of the wagon, a socket coupled to the cantilever proximate a distal end of the cantilever, a kingpin that rotatably engages the socket about a steering axis of rotation, at least one steering axle coupled to the kingpin for rotatably retaining at least one steering wheel to allow each steering wheel to swivel about the steering axis of rotation and a draw bar coupled to each steering axle to tow and steer the wagon.

### FIELD OF THE INVENTION

The invention generally relates to steerable running gear for a towable vehicle, and more particularly to a steerable running gear for a wagon that couples to one end of the wagon by way of a cantilever that extends away from one end of the wagon.

### BACKGROUND OF THE INVENTION

Conventional running gear for a wagon comprises at least two axles with at least two wheels per axle and wheels proximate each of four corners of the wagon. Such a wagon typically has a drawbar that extends from a front end of the wagon that couples through a linkage to wheels mounted on one of the axles under the wagon near the front end. Horizontal displacement of the drawbar during towing then directs the coupled front wheels to turn in the same direction to facilitate turns.

The linkage between the drawbar and the coupled front wheels adds complexity, cost and maintenance to wagons. Furthermore, because the coupled front wheels support the wagon proximate its two front corners, excessive tilting of these wheels during sharp turns may lead to instability of the wagon that may then cause the wagon to tip. Limiting the travel of the steering gear improves stability but limits manoeuvrability.

### SUMMARY OF THE INVENTION

A running gear for a wagon according to the invention comprises a cantilever extending away from one end of the wagon, a socket coupled to the cantilever proximate a distal end of the cantilever, a kingpin that rotatably engages the socket about a steering axis of rotation, at least one steering axle coupled to the kingpin for rotatably retaining at least one steering wheel to allow each steering wheel to swivel about the steering axis of rotation and a draw bar coupled to each steering axle to tow and steer the wagon through turns.

### DESCRIPTION OF THE DRAWINGS

FIGS. 1 and 2 are side and top views, respectively, of a towable vehicle or wagon with a steerable running gear according to a possible embodiment of the invention.

FIGS. 3 and 4 are detailed side and top views, respectively, of the steerable running gear according to a possible embodiment of the invention as shown in FIGS. 1 and 2.

### DETAILED DESCRIPTION OF THE INVENTION

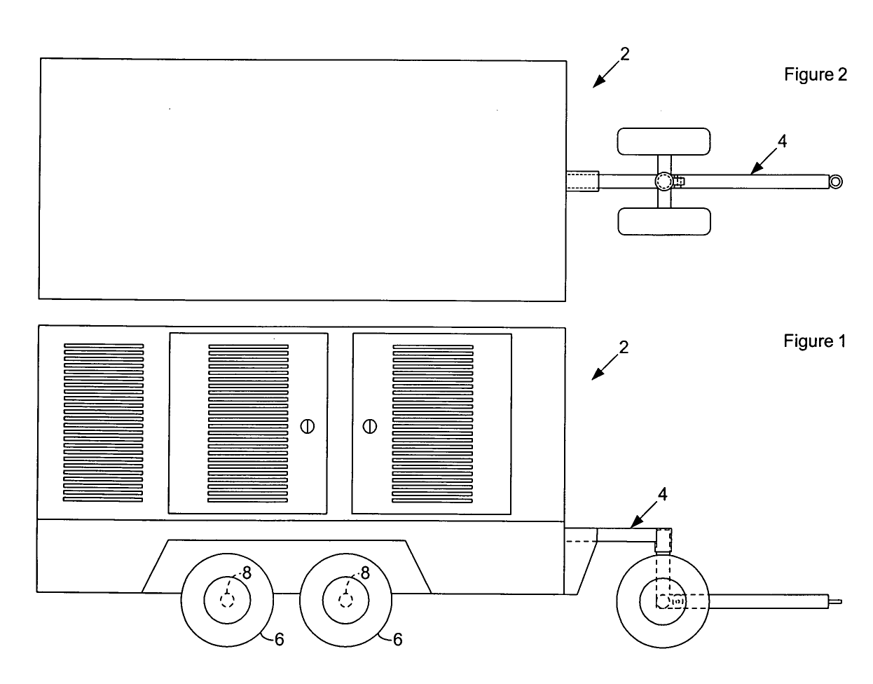

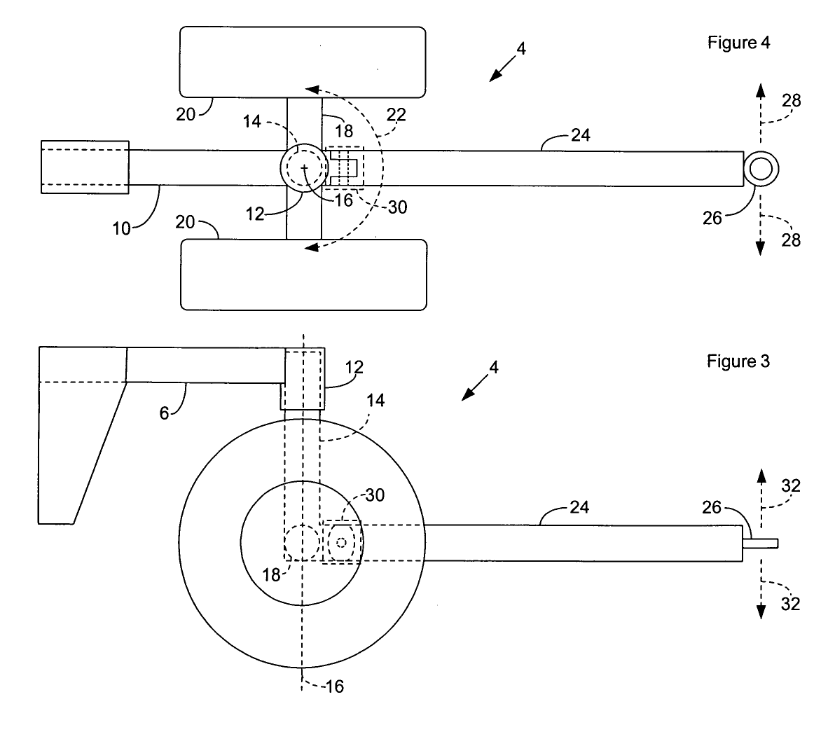

FIGS. 1 and 2 are side and top views, respectively, of a towable vehicle or wagon 2 with a steerable running gear 4 according to a possible embodiment of the invention. FIGS. 3 and 4 are detailed side and top views, respectively, of the steerable running gear 4 according to a possible embodiment of the invention as shown in FIGS. 1 and 2. Referring to FIGS. 1 through 4 together, a plurality of support wheels 6 coupled to the wagon 2 by way of at least one support axle 8 provide substantial support for the wagon 2 in a conventional manner. By way of example only, FIGS. 1 through 4 show four support wheels 6 coupled to the wagon 2 by way of two support axles 8. Alternatively, two support wheels 6 coupled to the wagon by a single support axle 8 or more than four support wheels 6 coupled to the wagon 2 by way of more than two support axles 8 may suit different applications of the wagon 2 depending on loading requirements. Furthermore, more than two support wheels 6 may couple to the wagon 2 by way of each support axle 8, such as four support wheels 6 per support axle 8.

A cantilever 10 extends away from one end of the wagon 2. A generally cylindrical bearing or socket 12 couples to the cantilever proximate a distal end of the cantilever 10. A kingpin 14 engages the socket 12 so that the kingpin 14 is free to rotate about a steering axis of rotation 16. At least one steering axle 18 that rotatably retains at least one steering wheel 20 couples to the kingpin 14 to allow each steering wheel 20 to swivel about the steering axis of rotation 16 as indicated by arrow 22. By way of example only, FIGS. 1 through 4 show two steering wheels rotatably retained by a single steering axle 18. Alternatively, a single steering axle 18 may rotatably retain a single steering wheel 20 or more than two steering wheels 20, such as four steering wheels 20, or a plurality of steering axles 18 may rotatably retain a plurality of steering wheels 20, such as two or four steering wheels 20 per steering axle 18.

A draw bar 24 couples to each steering axle 18 to tow and steer the wagon 2. The draw bar 24 may couple directly to each steering axle 18 or by way of attachment to the kingpin 14. A distal end of the draw bar 24 may have a coupler 26, such as a socket or ring, for coupling to a tow vehicle (not shown). In operation, towing the wagon 2 by way of the draw bar 24 through a turn causes the distal end of the draw bar 24 to travel in a direction indicated by arrows 28, thereby causing the kingpin 14 to rotate in the socket 12, which in turn causes each steering axle 18 to swivel each respective steering wheel 20 about the steering axis 16 and thereby steer the wagon 2 into the turn. The draw bar 24 may include one or more joints 30, such as a hinge or swivel, to allow vertical travel of the draw bar 24 as shown by arrows 32.

The hereinbefore-described embodiment of the invention is only an illustrative implementation of the invention wherein changes and substitutions of the various parts and arrangement thereof are within the scope of the invention as set forth in the attached claims.

What is claimed is:

1. A running gear for a wagon, comprising:
a cantilever extending away from one end of the wagon;
a socket coupled to the cantilever proximate a distal end of the cantilever;
a kingpin that rotatably engages the socket about a steering axis of rotation;
at least one steering axle coupled to the kingpin for rotatably retaining at least one steering wheel to allow each steering wheel to swivel about the steering axis of rotation; and
a draw bar coupled to each steering axle to tow and steer the wagon through turns.

2. The running gear of claim 1, wherein the wagon comprises a plurality of support wheels coupled to the wagon by way of at least one support axle.

3. The running gear of claim 1, wherein the wagon comprises four support wheels coupled to the wagon by way of two support axles.

4. The running gear of claim 1, wherein the wagon comprises two support wheels coupled to the wagon by way of a single support axle.

5. The running gear of claim 1, further comprising a single steering axle that rotatably retains two steering wheels.

6. The running gear of claim 1, further comprising a single steering axle that rotatably retains a single steering wheel.

7. The running gear of claim 1, further comprising a plurality of steering wheels that each rotatably retain a plurality of steering wheels.

8. The running gear of claim 1, wherein the draw bar couples directly to each steering axle.

9. The running gear of claim 1, wherein the draw bar couples to each steering axle by way of attachment to the kingpin.

10. The running gear of claim 1, wherein the draw bar further comprises at least one joint to allow vertical travel of the draw bar.

11. A running gear for a wagon that has a plurality of support wheels coupled to the wagon by way of at least one support axle, comprising:
a cantilever extending away from one end of the wagon;
a socket coupled to the cantilever proximate a distal end of the cantilever;
a kingpin that rotatably engages the socket about a steering axis of rotation;
a steering axle coupled to the kingpin for rotatably retaining at least one steering wheel to allow each steering wheel to swivel about the steering axis of rotation; and
a draw bar coupled to each steering axle to tow and steer the wagon through turns.

12. The running gear of claim 11, wherein the wagon comprises four support wheels coupled to the wagon by way of two support axles.

13. The running gear of claim 11, further comprising a single steering axle that rotatably retains two steering wheels.

14. The running gear of claim 11, wherein the draw bar further comprises at least one joint to allow vertical travel of the draw bar.

15. A wagon with steerable running gear comprising:
a plurality of support wheels coupled to the wagon by way of at least one support axle,
a cantilever extending away from one end of the wagon;
a socket coupled to the cantilever proximate a distal end of the cantilever;
a kingpin that rotatably engages the socket about a steering axis of rotation;
a steering axle coupled to the kingpin for rotatably retaining at least one steering wheel to allow each steering wheel to swivel about the steering axis of rotation; and
a draw bar coupled to each steering axle to tow and steer the wagon through turns.

16. The wagon of claim 15, further comprising four support wheels coupled to the wagon by way of two support axles.

17. The wagon of claim 15, further comprising two support wheels coupled to the wagon by way of a single support axle.

18. The wagon of claim 15, further comprising a single steering axle that rotatably retains two steering wheels.

19. The wagon of claim 15, further comprising a single steering axle that rotatably retains a single steering wheel.

20. The wagon of claim 15, further comprising a plurality of steering wheels that each rotatably retain a plurality of steering wheels.

21. The wagon of claim 15, wherein the draw bar couples directly to each steering axle.

22. The wagon of claim 15, wherein the draw bar couples to each steering axle by way of attachment to the kingpin.

23. The wagon of claim 15, wherein the draw bar further comprises at least one joint to allow vertical travel of the draw bar.
